(19) United States
(12) Patent Application Publication
(10) Pub. No.: US 2024/0083081 A1
(43) Pub. Date: Mar. 14, 2024

(54) Method for wrapping edge of PEAK racket

(71) Applicants: Jiuxian Liu, Nanchang (CN); Hongping Xu, Nanchang (CN)

(72) Inventors: Jiuxian Liu, Nanchang (CN); Hongping Xu, Nanchang (CN)

(21) Appl. No.: 18/382,041

(22) Filed: Oct. 19, 2023

(51) Int. Cl. B29C 45/14; B32B 3/08; B32B 3/12; B32B 5/02; B32B 5/18; B32B 5/24

(52) U.S. Cl. CPC B29C 45/14336; B32B 3/08; B32B 3/12; B32B 5/02; B32B 5/18; B32B 5/245; A63B 59/42

(57) ABSTRACT

A method for wrapping an edge of a PEAK racket by injection molding is provided. The method includes the steps of manufacturing and preparing a preliminary embryo of a racket, where the preliminary embryo of the racket includes a racket body and a handle that is integrally connected to the racket body; mounting a racket mold on an injection molding machine, and placing the preliminary embryo of the racket into the racket mold; placing plastic particles into the injection molding machine, to melt the plastic particles in a liquid form, where the liquid plastic flows into the racket mold and is combined with a peripheral side surface of the preliminary embryo of the racket, to form a wrapped edge; and after cooling, wrapping the wrapped edge, and fastening the wrapped edge to the peripheral side surface of the preliminary embryo of the racket to form a finished product.

### BACKGROUND OF THE INVENTION

### 1. Field of the Invention

The invention relates to rackets and more particularly to a method for wrapping an edge of a PEAK racket.

### 2. Description of Related Art

A pickleball, a sport played with a racket, is on the rise from Bainbridge Island in Washington state of the United States. It is best described as a mixture of tennis, badminton, and table tennis. The pickleball was invented by two men. A name of “pickle” ball comes from a dog of one of the inventors. A dog, named Pickle, used to run with the ball in its mouth when the invention tries to bite the ball.

A racket used to hit the pickleball is called a PEAK racket. At present, the PEAK racket mainly includes a body. The body includes a substrate layer and two panels. The two panels are respectively stacked on two surfaces of the substrate layer. The body includes a racket body and a handle that is integrally connected to the racket body. To beautify the PEAK racket, a wrapping process needs to be performed usually. In a conventional technology, it is common to first manufacture and molding a wrapped edge and a wrapped edge that is molded by hot pressing short fibers, and adhere and fasten the wrapped edge to a peripheral side surface of a body by using a strong glue. Production efficiency of this manner is very low. Because of using a glue, the production efficiency of this manner is not environmental-friendly. In addition, because of limitation to an adhering technology of a production person, appearance of the product cannot be guaranteed. Therefore, it is necessary to study a solution to resolve the foregoing problems.

### SUMMARY OF THE INVENTION

In view of this, to resolve problems existing in a conventional technology, a main purpose of the invention is to provide a method for wrapping an edge of a PEAK racket. The method for wrapping an edge of a PEAK racket can effectively resolve problems that efficiency of an existing manufacturing and producing method for a racket is low and appearance is not guaranteed.

To achieve the foregoing objective, the following technical solutions are used in the invention.

A method for wrapping an edge of a PEAK racket by injection molding comprises the steps of manufacturing and preparing a preliminary embryo of a racket, where the preliminary embryo of the racket includes a racket body and a handle that is integrally connected to the racket body; mounting a racket mold on an injection molding machine, and placing the preliminary embryo of the racket into the racket mold; placing plastic particles into the injection molding machine, to melt the plastic particles in a liquid form, where the liquid plastic flows into the racket mold and is combined with a peripheral side surface of the preliminary embryo of the racket, to form a wrapped edge; and after cooling, wrapping the wrapped edge, and fastening the wrapped edge to the peripheral side surface of the preliminary embryo of the racket, to form a finished product, and taking out the finished product from the racket mold.

Preferably, the injection molding machine is a vertical injection molding machine.

Preferably, the preliminary embryo of the racket includes a substrate layer and two panels, and the two panels are respectively stacked on two surfaces of the substrate layer.

Preferably, the substrate layer is made of a foam honeycomb material.

Preferably, the panel is a glass fiber panel or a carbon fiber panel.

Compared with the conventional art, the invention has obvious advantages and beneficial effects. Specifically, it may be learned from the foregoing technical solution.

The wrapped edge is directly molded on the peripheral side surface of the preliminary embryo of the racket by injection molding, to enable the wrapped edge to be well fastened to the peripheral side surface of the preliminary embryo of the racket. This replaces a conventional manner of first molding the wrapped edge and adhering the wrapped edge by using the strong glue. According to the invention, the strong glue does not need to be used, so that production efficiency is effectively improved. In addition, a plastic material used may be recycled, without using the strong glue, so that the method is more environmental-friendly, and appearance of the racket is more beautiful and comfortable.

The above and other objects, features and advantages of the invention will become apparent from the following detailed description taken with the accompanying drawings.

### BRIEF DESCRIPTION OF THE DRAWINGS

FIG. 1 is a front view of a racket according to a preferred embodiment of the invention; and

FIG. 2 is a sectional view taken along line 2-2 of FIG. 1.

### DETAILED DESCRIPTION OF THE INVENTION

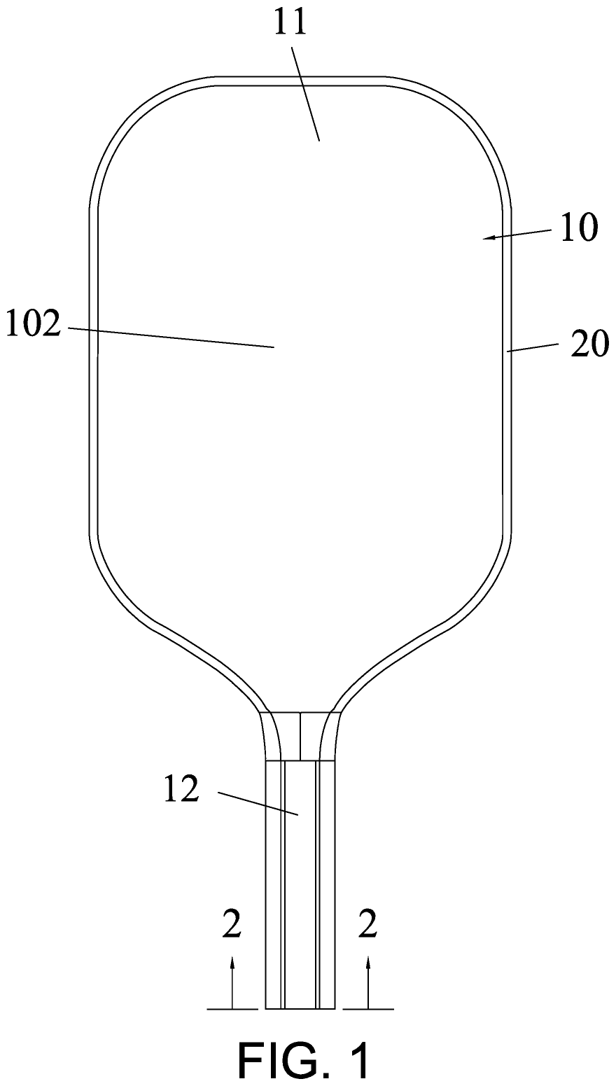

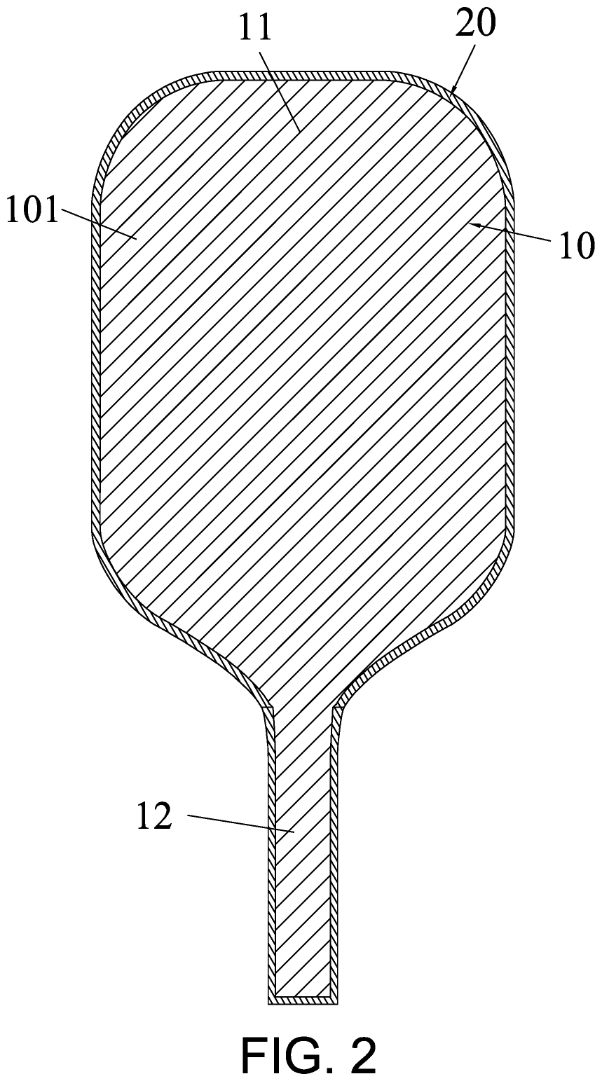

Referring to FIGS. 1 to 2, a method for wrapping an edge of a PEAK racket by injection molding according to the invention comprises the following steps.

(1) Manufacture and prepare a preliminary embryo of a racket 10, where the preliminary embryo 10 of the racket includes a racket body 11 and a handle 12 that is integrally connected to the racket body 11. Specifically, the preliminary embryo 10 of the racket includes a substrate layer 101 and two panels 102. The two panels 102 are respectively stacked on two surfaces of the substrate layer 101. A structure is simple, and manufacturing is convenient. The substrate layer 101 is made of a foam honeycomb material, and the panel 102 is a glass fiber panel or a carbon fiber panel.

(2) Mount a racket mold on an injection molding machine, and placing the preliminary embryo 10 of the racket into the racket mold. In this embodiment, the injection molding machine is a vertical injection molding machine, to perfectly perform wrapping on the preliminary embryo 10 of the racket by injection molding.

(3) Place plastic particles into the injection molding machine, to melt the plastic particles in a liquid form, where the liquid plastic flows into the racket mold and is combined with a peripheral side surface of the preliminary embryo 10 of the racket, to form a wrapped edge 20.

(4) After cooling, wrap the wrapped edge 20, and fastening the wrapped edge to the peripheral side surface of the preliminary embryo 10 of the racket, to form a finished product, and taking out the finished product from the racket mold.

Key points of design in the invention are: The wrapped edge is directly molded on the peripheral side surface of the preliminary embryo of the racket by injection molding, to enable the wrapped edge to be well fastened to the peripheral side surface of the preliminary embryo of the racket. This replaces a conventional manner of first molding the wrapped edge and adhering the wrapped edge by using the strong glue. According to the invention, the strong glue does not need to be used, so that production efficiency is effectively improved. In addition, a plastic material used may be recycled, without using the strong glue, so that the method is more environmental-friendly, and appearance of the racket is more beautiful and comfortable.

The technical principles of the invention are described above with reference to the specific embodiments. These descriptions are merely intended to explain the principles of the invention, and may not be construed as limiting the protection scope of the invention in any way. Therefore, those skilled in the art may derive other specific implementations of the invention without creative effort, but these implementations should fall within the protection scope of the invention.

While the invention has been described in terms of preferred embodiments, those skilled in the art will recognize that the invention can be practiced with modifications within the spirit and scope of the appended claims.

What is claimed is:

1. A method for wrapping an edge of a PEAK racket by injection molding, comprising the steps of:
(1) manufacturing and preparing a preliminary embryo of a racket, wherein the preliminary embryo of the racket comprises a racket body and a handle that is integrally connected to the racket body;
(2) mounting a racket mold on an injection molding machine, and placing the preliminary embryo of the racket into the racket mold;
(3) placing plastic particles into the injection molding machine, to melt the plastic particles in a liquid form, wherein the liquid plastic flows into the racket mold and is combined with a peripheral side surface of the preliminary embryo of the racket, to form a wrapped edge; and
(4) after cooling, wrapping the wrapped edge, and fastening the wrapped edge to the peripheral side surface of the preliminary embryo of the racket, to form a finished product, and taking out the finished product from the racket mold.

2. The method of claim 1, wherein the injection molding machine is a vertical injection molding machine.

3. The method of claim 1, wherein the preliminary embryo of the racket comprises a substrate layer and two panels, and the two panels are respectively stacked on two surfaces of the substrate layer.

4. The method of claim 3, wherein the substrate layer is made of a foam honeycomb material.

5. The method of claim 3, wherein the panel is a glass fiber panel or a carbon fiber panel.
